(19) United States
(12) Patent Application Publication
(10) Pub. No.: US 2013/0196687 A1
(43) Pub. Date: Aug. 1, 2013

(54) COMMUNICATION TERMINAL

(71) Applicants: Mikio Iwamura, Chiyoda-ku (JP); Wuri Andarmawanti Hapsari, Chiyoda-ku (JP)

(72) Inventors: Mikio Iwamura, Chiyoda-ku (JP); Wuri Andarmawanti Hapsari, Chiyoda-ku (JP)

(73) Assignee: NTT DOCOMO, INC., Tokyo (JP)

(21) Appl. No.: 13/813,707

(22) PCT Filed: Aug. 2, 2011
(86) PCT No.: PCT/JP11/67661

§ 371 Date: Apr. 10, 2013

(30) Foreign Application Priority Data
Aug. 3, 2010 (JP) 2010-174355

(51) Int. Cl. H04W 4/02

(52) U.S. Cl. CPC H04W 4/02
USPC 455/456.1

(57) ABSTRACT

In a communication terminal 1 according to the present invention, a radio communication device 12 includes a measurement unit 12B that measures a predetermined radio quality according to an instruction “MDT Configuration” from a radio base station eNB; an acquisition unit 12C that acquires the location information of the communication terminal 1 notified by a positioning device 14; and a transmission unit 12D that transmits a measurement report “MDT Log Report” including the location information of the communication terminal 1 and the measurement result of the predetermined radio quality to a radio base station eNB.

### TECHNICAL FIELD

The present invention relates to a communication terminal including a positioning device and a radio communication device.

### BACKGROUND ART

“MDT (Minimisation of Drive Tests)” is being discussed in 3GPP.

“MDT” is a test in which it is possible to replace the conventional measurement of the radio wave status by communication providers with the measurement result of the radio wave status reported by a radio communication device (UE: User Equipment), and includes “Immediate MDT” and “Logged MDT”.

The “Intermediate MDT” is configured such that the radio wave status is understood by statistically processing the measurement report from the radio communication device in the “RRC_CONNECTED” state, at the network side. In the measurement report, the usual measurement report for “RRM (Radio Resource Management)” is either applied as is or is expanded slightly.

On the other hand, the “Logged MDT” is configured such that the radio communication device is configured to store the measurement result of the radio wave status, and then later transmit a measurement report including a series of measurement results. While the application of “Logged MDT” in a radio communication device in the “RRC_IDLE” state is decided, whether or not to apply “Logged MDT” in a radio communication device in the “RRC_CONNECTED” state is not decided.

### CITATION LIST

### Non Patent Literature

[NPL 1] 3GPP TR36.805 v9.0.0

In order to view “MDT” as a meaningful solution, it is necessary to acquire the accurate location information of the radio communication device correlated with the measurement result of the radio wave status.

Currently, it is assumed that in MDT, the radio communication device reports the location information of the radio communication device based on best effort, when the measurement results are reported.

That is, in MDT, when the location information of the radio communication device acquired at the time of measuring the radio wave status exists, the radio communication device is assumed to report the location information of the radio communication device.

However, there is a problem with the conventional MDT that if the difference between the timing of measuring the radio wave status and the timing of acquiring the location information of the radio communication device is large, an accurate radio wave status cannot be acquired.

### SUMMARY OF THE INVENTION

Thus, the present invention has been achieved in view of the aforementioned problem, and an object thereof is to provide a communication terminal with which it is possible to acquire an accurate radio wave status.

A first characteristic of the present invention is summarized as a communication terminal including a positioning device and a radio communication device, such that the radio communication device includes a measurement unit that measures a predetermined radio quality according to an instruction from a radio base station; an acquisition unit that acquires the location information of the communication terminal notified by the positioning device; and a transmission unit that transmits a measurement report including the location information of the communication terminal and the measurement result of the predetermined radio quality to the radio base station.

As described above, according to the present invention, it is possible to provide a communication terminal that enables the acquisition of an accurate radio wave status.

### BRIEF DESCRIPTION OF DRAWINGS

FIG. 1 is a diagram showing the entire configuration of a mobile communication system according to a first embodiment of the present invention.

FIG. 2 is a functional block diagram of a communication terminal according to the first embodiment of the present invention.

FIG. 3 is a functional block diagram of a radio communication device in the communication terminal according to the first embodiment of the present invention.

FIG. 4 is a sequence diagram for explaining an operation of the mobile communication system according to the first embodiment of the present invention.

FIG. 5 is a functional block diagram of a communication terminal according to a first modification of the present invention.

FIG. 6 is a functional block diagram of a radio communication device in the communication terminal according to the first modification of the present invention.

### DESCRIPTION OF EMBODIMENTS

(Mobile Communication System According to First Embodiment of the Present Invention)

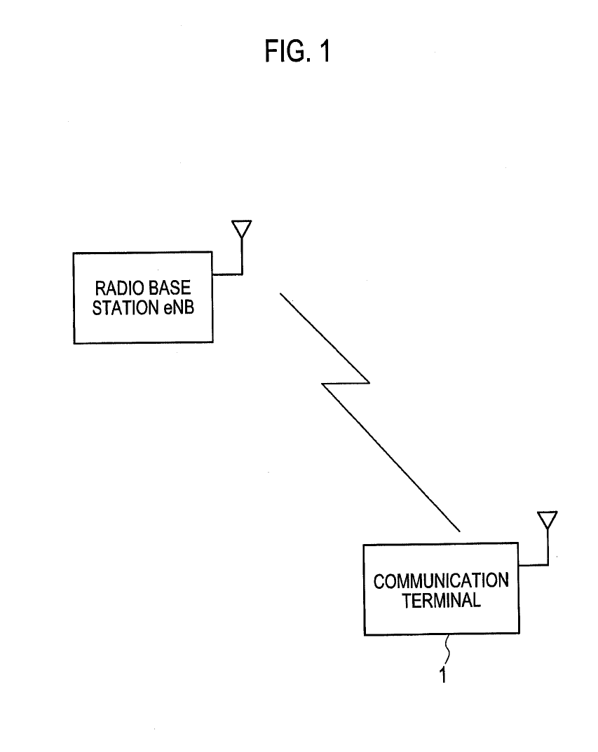

With reference to FIG. 1 through FIG. 4, a mobile communication system according to a first embodiment of the present invention will be described.

As illustrated in FIG. 1, in the mobile communication system according to the present embodiment, a communication terminal 1 is configured to perform radio communication with a radio base station eNB, which is a radio access network device based on an LTE (Long Term Evolution) scheme.

It is assumed that the communication terminal 1 according to the present embodiment, for example, is a vehicle-mounted navigation device.

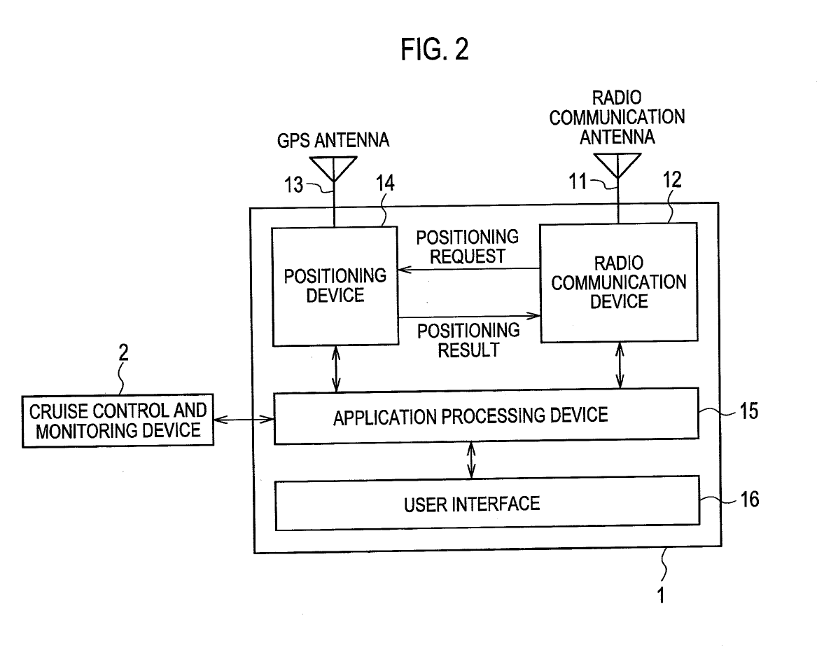

As illustrated in FIG. 2, the communication terminal 1 according to the present embodiment includes a radio communication antenna 11, a radio communication device 12, a GPS (Global Positioning System) antenna 13, a positioning device 14, an application processing device 15, and a user interface 16.

The communication terminal 1 according to the present embodiment may be configured to connect with an external application processing device rather than including the application processing device 15.

The radio communication device 12 includes the function as a mobile station UE in a mobile communication system based on the LTE scheme, specifically, the radio communication device includes the function as an MTC (Machine Type Communication) module. For example, the radio communication device 12 according to the present embodiment is a ubiquitous module.

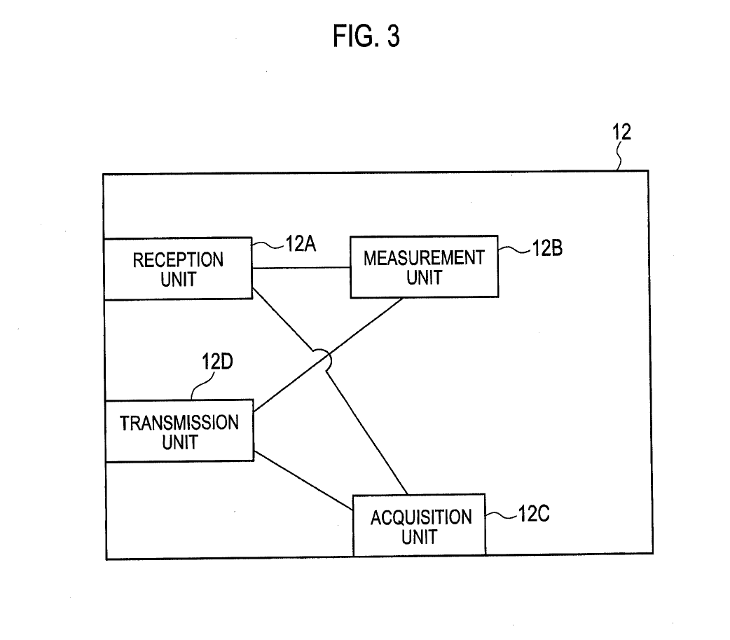

Specifically, as illustrated in FIG. 3, the radio communication device 12 includes a reception unit 12A, a measurement unit 12B, an acquisition unit 12C, and a transmission unit 12D.

The reception unit 12A is configured to receive a signal transmitted by the radio base station eNB via the radio communication antenna 11.

For example, when the mobile station UE is in an “RRC_CONNECTED” state in a cell #1 subordinate to a radio access network RAN #1, the reception unit 12A is configured to receive “MDT Configuration” as an RRC (Radio Resource Control) signal from the radio base station eNB managing the cell #1.

The measurement unit 12B is configured to measure a predetermined radio quality by the measurement method specified by “MDT Configuration”, and generate an “MDT Log Report (measurement report)” including the measurement result.

The radio quality to be measured may also include the “Reference Signal Received Power (RSRP)” and “Reference Signal Received Quality (RSRQ)” of the current serving cell and the neighboring cells.

Furthermore, the measurement unit 12B may be configured to generate a measurement report “MDT Log Report” correlating the location information of the communication terminal 1 and the measurement result of the predetermined radio quality by using the time stamp (time information) notified from the positioning device 14.

The measurement unit 12B may be configured to measure the predetermined radio quality at the timing of notification of the location information of the communication terminal 1 by the positioning device 14.

The acquisition unit 12C is configured to acquire the location information of the communication terminal 1 from the positioning device 14.

The acquisition unit 12C may be configured to set the timing (for example, a cycle) of notifying the location information of the communication terminal 1 to the positioning device 14.

Furthermore, the acquisition unit 12C may be configured to synchronize the time information with the positioning device 14 when a request for the location information of the communication terminal 1 is sent to the positioning device 14. That is, the acquisition unit 12C may be configured to match the clock managed at the side of the positioning device 14 with the clock managed at the side of the radio communication device 12.

The transmission unit 12D is configured to transmit a signal to the radio base station eNB via the radio communication antenna 11.

For example, when the mobile station UE is in the “RRC_CONNECTED” state, the transmission unit 12D is configured to transmit the “MDT Log Report” generated by the measurement unit 12B to the radio base station eNB by the reporting method specified by “MDT Configuration”.

Furthermore, the transmission unit 12D may be configured to transmit the above measurement report “MDT Log Report” when the amount of change of the location information of the communication terminal 1 falls below a predetermined threshold value.

The radio communication device 12 may be configured to perform a process of downloading and uploading an application and data.

The positioning device 14 is configured to perform a process of positioning the communication terminal 1, that is, to acquire the location information (positioning information) of the communication terminal 1. For example, the positioning device 14 according to the present embodiment is a navigation system.

Specifically, the positioning device 14 is configured to acquire the location information (positioning information) of the communication terminal 1 using GPS, via the GPS antenna 13.

Alternatively, the positioning device 14 may be configured to acquire the location information (positioning information) of the communication terminal 1 using another method such as LCS (Location Services).

Furthermore, the positioning device 14 may be configured to periodically transmit the location information of the communication terminal 1 to the radio communication device 12, or may be configured to transmit the location information of the communication terminal 1 to the radio communication device 12 at a timing (alternatively, in a cycle) set by the radio communication device 12.

Furthermore, the measurement device 14 may be configured to notify a time stamp along with the location information of the communication terminal 1 to the radio communication device 12.

The application processing device 15 is configured to perform application processing such as map information processing, voice guide processing, and recreation information processing.

Furthermore, the application processing device 15 may be configured to perform the process of downloading a cruise control application and the process of uploading cruise monitoring data with respect to a cruise control and monitoring system 2.

The user interface 16 is configured to perform map display processing, voice guide playback processing, music and video playback processing, and command input processing.

The cruise control and monitoring system 2 is configured to perform the cruise control processing and the running state monitoring process of the vehicle on which the communication terminal 1 is loaded.

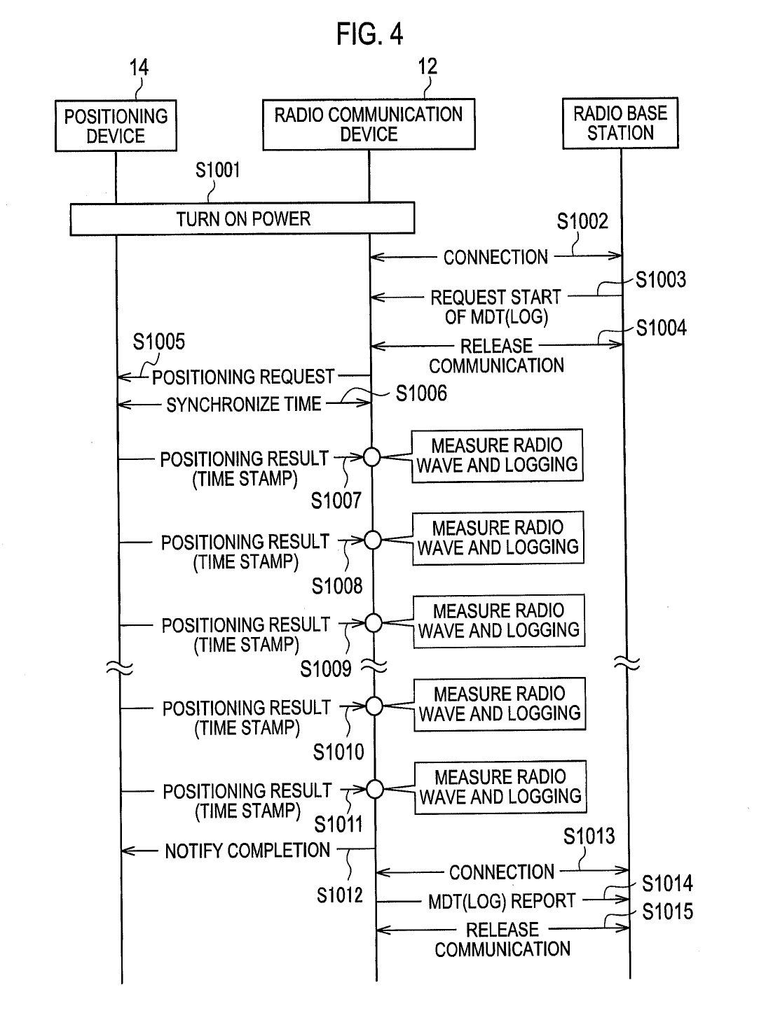

Hereinafter, with reference to FIG. 4, an example of the operation of the mobile communication system according to the first embodiment of the present invention will be described.

As illustrated in FIG. 4, when the power supply to the communication terminal 1 is turned ON in step S1001, the radio communication device 12 establishes an RRC connection with the radio base station eNB, and transits from the “RRC_IDLE” state to the “RRC_CONNECTED” state in step S1002.

In step S1003, the radio base station eNB requests the start of measurement according to MDT by transmitting “MDT Configuration” to the radio communication device 12.

In step S1004, the radio communication device 12 releases the RRC connection established with the radio base station eNB, and transits from the “RRC_CONNECTED” state to the “RRC_IDLE” state.

Upon receiving the “MDT Configuration” transmitted by the radio base station eNB, the radio communication device 12 transmits a positioning request to the positioning device 14 in step S1005, and at the same time, synchronizes the time stamp (time information) with the positioning device 14 in step S1006.

In steps S1007 through S1011, the radio communication device 12 receives the location information (positioning information) of the communication terminal 1 acquired by the positioning device 14, and at the same time, the radio communication device 12 measures the predetermined radio quality (radio wave status) specified by “MDT Configuration”, and stores both.

In step S1012, the radio communication device 12 notifies the completion of the measurement according to MDT to the positioning device 14.

In step S1013, the radio communication device 12 establishes an RRC connection with the radio base station eNB at the timing specified by “MDT Configuration”, and transits from the “RRC_IDLE” state to the “RRC_CONNECTED” state.

In step S1014, the radio communication device 12 transmits “MDT Log Report” including a plurality of aforementioned combinations of the location information of the communication terminal 1 and the measurement result of the predetermined radio quality, to the radio base station eNB.

In step S1015, the radio communication device 12 releases the RRC connection established with the radio base station eNB, and transits from the “RRC_CONNECTED” state to the “RRC_IDLE” state.

The communication terminal 1 according to the present embodiment may be configured to be connected to a fixed power supply. According to such a configuration, the concerns over the battery are done away with, and the measurement frequency can be increased.

The communication terminal 1 according to the present embodiment may be configured to be loaded in an automatic vending machine or a smart meter. According to such a configuration, MDT can be used (that is, secondary usage of the location information of the communication terminal 1) without any problem, from the viewpoint of personal information protection.

(First Modification)

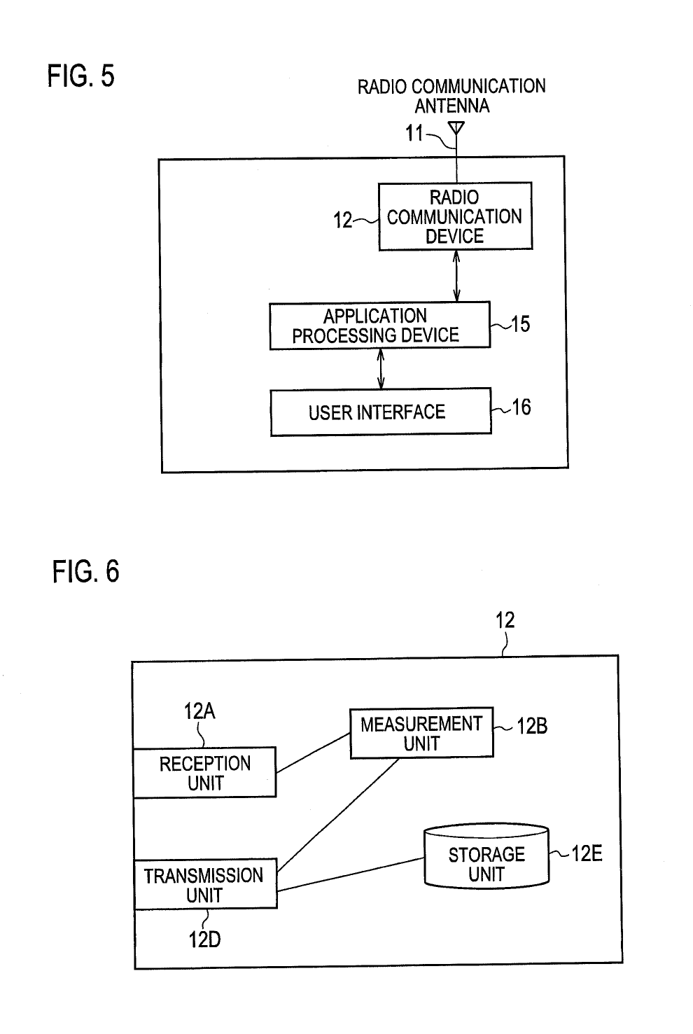

With reference to FIG. 5 and FIG. 6, a mobile communication system according to a first modification of the present invention will be described while focusing on the difference from the mobile communication system according to the aforementioned first embodiment.

As illustrated in FIG. 5, the communication terminal 1 according to the present first modification includes the radio communication antenna 11, the radio communication device 12, the application processing device 15, and the user interface 16.

Furthermore, as illustrated in FIG. 6, the radio communication device 12 of the communication terminal 1 according to the present first modification includes the reception unit 12A, the measurement unit 12B, the transmission unit 12D, and a storage unit 12E.

The communication terminal 1 according to the present first modification is assumed to be loaded in an automatic vending machine or a smart meter. Therefore, as illustrated in FIG. 5, the positioning device 14 illustrated in FIG. 2 is not provided in the communication terminal 1 according to the present first modification. Instead, the storage unit 12E is configured to store the location information of the communication terminal 1 beforehand.

The communication terminal 1 according to the present first modification may be configured to be connected to a fixed power supply.

According to such a configuration, the concerns over the battery are done away with, and the measurement frequency can be increased. According to the mobile communication system of the first modification of the present invention, because the radio communication device 12 is configured to measure the predetermined radio quality at the timing of acquiring the location information of the communication terminal 1 from the positioning device 14, the difference between the timing of measuring the radio wave status and the timing of acquiring the location information of the radio communication device can be reduced, and an accurate radio wave status can be acquired.

According to the mobile communication system of the first modification of the present invention, the positioning device 14 may only perform positioning at the timing set by the radio communication device 12.

Therefore, an accurate radio wave status can be acquired without consuming the battery significantly.

The characteristics of the present embodiment as described above may be expressed as follows.

A first characteristic of the present embodiment is summarized as a communication terminal 1 including a positioning device 14 and a radio communication device 12, such that the radio communication device 12 includes a measurement unit 12B that measures a predetermined radio quality according to an instruction “MDT Configuration” from a radio base station eNB; an acquisition unit 12C that acquires the location information of the communication terminal 1 notified by the positioning device 14; and a transmission unit 12D that transmits a measurement report “MDT Log Report” including the location information of the communication terminal 1 and the measurement result of the predetermined radio quality to the radio base station eNB.

In the first characteristic of the present embodiment, the positioning device 14 may be configured to periodically transmit the location information of the communication terminal 1 to the radio communication device 12.

In the first characteristic of the present embodiment, the acquisition unit 12C may be configured to set the timing of notifying the location information of the communication terminal 1 to the positioning device 14.

In the first characteristic of the present embodiment, the measurement unit 12B may be configured to measure a predetermined radio quality at the timing of notification of the location information of the communication terminal 1 by the positioning device 14.

In the first characteristic of the present embodiment, the positioning device 14 may be configured to notify the time information along with the location information of the communication terminal 1.

In the first characteristic of the present embodiment, the measurement unit 12B may be configured to generate a measurement report “MDT Log Report” correlating the location information of the communication terminal 1 and the measurement result of the predetermined radio quality by using the time information.

In the first characteristic of the present embodiment, the acquisition unit 12C may be configured to synchronize the time information with the positioning device 14 when a request for the location information of the communication terminal 1 is sent to the positioning device 14.

In the first characteristic of the present embodiment, the transmission unit 12D may be configured to transmit the above measurement report “MDT Log Report” when the amount of change of the location information of the communication terminal 1 falls below a predetermined threshold value.

In the first characteristic of the present embodiment, the communication terminal 1 may be a vehicle mounted type.

A second characteristic of the present embodiment is summarized as a communication terminal 1 including a radio communication device 12, such that the radio communication device 12 includes a measurement unit 12B that measures a predetermined radio quality according to an instruction

“MDT Configuration” from a radio base station eNB; a storage unit 12D that stores the location information of the communication terminal 1; and a transmission unit 12D that transmits a measurement report “MDT Log Report” including the location information of the communication terminal 1 and the measurement result of the predetermined radio quality to the radio base station eNB.

In the first and the second characteristics of the present embodiment, the communication terminal 1 may be configured to be connected to a fixed power supply.

In the first and the second characteristics of the present embodiment, the communication terminal 1 may be configured to be loaded in an automatic vending machine.

In the first and the second characteristics of the present embodiment, the communication terminal 1 may be configured to be loaded in a smart meter.

In addition, the operation of the aforementioned radio base station eNB and communication terminal 1 may be implemented by hardware, may also be implemented by a software module executed by a processor, or may further be implemented by the combination of both.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such a storage medium and processor may be arranged in an ASIC. Such an ASIC may be arranged in the radio base station eNB or the communication terminal 1. As a discrete component, such a storage medium and processor may be arranged in the radio base station eNB or the communication terminal 1.

Thus, the present invention has been explained in detail by using the above-mentioned embodiments; however, it is obvious that for persons skilled in the art, the present invention is not limited to the embodiments explained herein. The present invention can be implemented as a corrected and modified mode without departing the gist and the scope of the present invention defined by the claims. Therefore, the description of the specification is intended for explaining the example only and does not impose any limited meaning to the present invention.

1. A communication terminal including a positioning device and a radio communication device, wherein
the radio communication device comprises:
a measurement unit that measures a predetermined radio quality according to an instruction from a radio base station;
an acquisition unit that acquires the location information of the communication terminal notified by the positioning device; and
a transmission unit that transmits a measurement report including the location information of the communication terminal and the measurement result of the predetermined radio quality to the radio base station, and
the positioning device is configured to periodically transmit the location information of the communication terminal to the radio communication device.

2. (canceled)

3. A communication terminal including a positioning device and a radio communication device, wherein
the radio communication device comprises:
a measurement device that measures a predetermined radio quality according to an instruction from a radio base station;
an acquisition unit that acquires the location information of the communication terminal notified by the positioning device; and
a transmission unit that transmits a measurement report including the location information of the communication terminal and the measurement result of the predetermined radio quality to the radio base station, and
the measurement device is configured to notify the time information along with the location information of the communication terminal.

4.-5. (canceled)

6. The communication terminal according to claim 3, wherein the measurement unit is configured to generate the measurement report correlating the location information of the communication terminal and the measurement result of the predetermined radio quality by using the time information.

7. The communication terminal according to claim 3, wherein the acquisition unit is configured to synchronize the time information with the positioning device when a request for the location information of the communication terminal is sent to the positioning device.

8. The communication terminal according to claim 1, wherein the transmission unit is configured to transmit the measurement report when the amount of change of the location information of the communication terminal falls below a predetermined threshold value.

9. The communication terminal according to claim 1 that is a vehicle mounted type.

10.-13. (canceled)
